(19) United States
(12) Patent Application Publication
(10) Pub. No.: US 2009/0136342 A1
(43) Pub. Date: May 28, 2009

(54) Duct installation

(75) Inventor: Michael J. Westlake, Charfield (GB)

Correspondence Address: OLIFF & BERRIDGE, PLC, P.O. BOX 320850, ALEXANDRIA, VA, 22320-4850, US

(73) Assignee: ROLLS-ROYCE PLC, LONDON (GB)

(21) Appl. No.: 12/081,654

(22) Filed: Apr. 18, 2008

(30) Foreign Application Priority Data
May 24, 2007 (GB) 0709949.2

(51) Int. Cl. F01D 25/24; F02C 7/00

(52) U.S. Cl. 415/214.1

(57) ABSTRACT

A duct installation, for example a casing 4 and an exhaust duct 8 of a gas turbine engine, comprises a main body 12 and an end section 14 of the casing 4 which are separable at a coupling including end flanges 18, 20. The end section 14 is axially slidable over the exhaust duct 8, taking with it a liner section 36, so as to provide access to the engine or to permit removal of the engine without disturbing the exhaust duct 8.

This invention relates to a duct installation and is particularly, although not exclusively, concerned with such an installation comprising a gas turbine engine casing which is connected to an exhaust duct such as a jet pipe.

It is usual for the exhaust duct of a gas turbine engine to be a component separate from the casing enclosing the engine. The exhaust duct is connected to the casing in a sealed manner. When the engine is installed in an aircraft with the exhaust duct connected to the engine casing, the exhaust duct can obstruct access to the rear of the engine for inspection purposes. Also, removal of the engine from the airframe may be hindered if removal is attempted while the exhaust duct remains connected to the casing. Consequently, it is known to provide for the exhaust duct to be releasably connected to the engine casing so that it can be disconnected, and moved away from the engine casing, to provide access for inspection instruments through the gap between the engine casing and the exhaust duct.

In some circumstances, it is undesirable for the exhaust duct to be displaced with respect to the airframe. However, if the exhaust duct is fixed, it becomes impossible to access the rear of the engine unless the engine itself is moved away from the exhaust duct, or removed entirely from the aircraft.

According to the present invention there is provided an exhaust duct installation for a gas turbine engine comprising a first tubular member having a central axis, and a second tubular member which is connected to one end of the first tubular member, characterised in that the first tubular member comprises a main body and an end section which engages the second tubular member, the end section being connected to the main body by a releasable coupling, and being axially displaceable with respect to the second tubular member in a direction away from the main body, following release of the coupling.

The second tubular member may be received telescopically within the end section. A sealing member may be disposed radially between the end section and the second tubular member.

The coupling may comprise end flanges on the main body and the end member, which end flanges abut each other at respective transverse faces. The transverse faces may be provided with axial locating means. The coupling may further comprise a clamping member which is releasably fitted over the flanges to maintain them in engagement with each other. The flanges may have respective external surfaces which converge in a radially outwards direction, the clamping member comprising a circumferential channel having internal surfaces which are complementary to the external surfaces of the flanges, and means for circumferentially tensioning the channel.

The first tubular member may comprise a casing of a gas turbine engine, and the second tubular member may comprise an exhaust duct of the gas turbine engine.

Other aspects of the present invention provide a gas turbine engine including a duct installation as defined above, and an aircraft having such a gas turbine engine, the exhaust duct being fixed in position with respect to an airframe of the aircraft.

For a better understanding of the present invention, and to show more clearly how it may be carried into effect, reference will now be made, by way of example, to the accompanying drawings, in which:

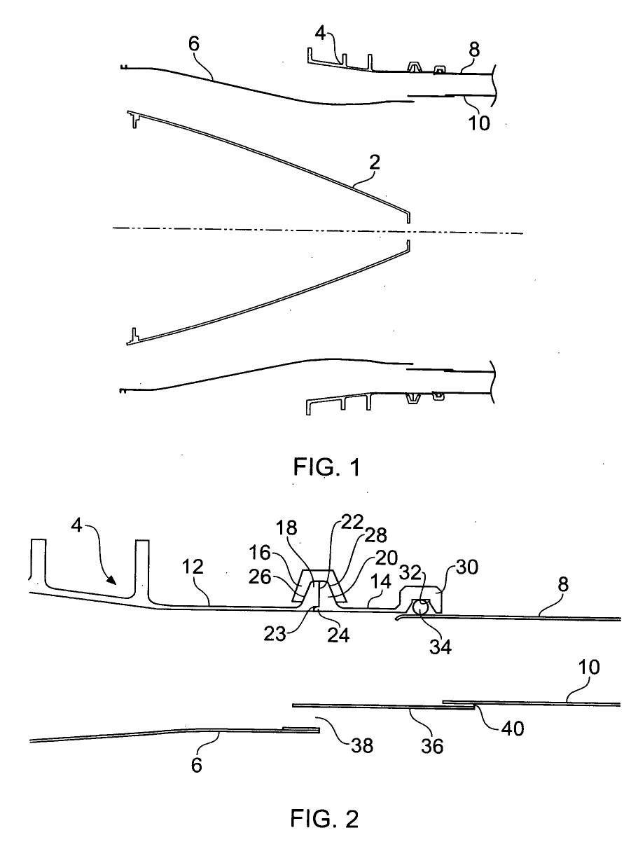

FIG. 1 is a cross-sectional view of the rear end of a gas turbine engine;

FIG. 2 is an enlarged view of part of FIG. 1; and

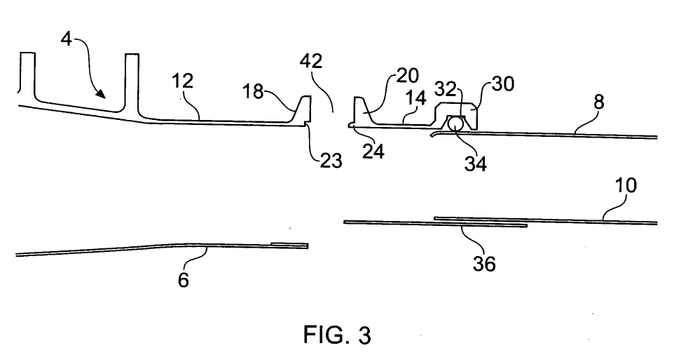

FIG. 3 corresponds to FIG. 2 but shows the components in an alternative configuration.

The engine illustrated in FIG. 1 comprises an exhaust cone 2 extending into a rear casing 4. A liner 6 extends around the exhaust cone 2 and is supported within the casing 4 by suitable support structures (not shown).

An exhaust duct or jet pipe 8 extends from the casing 4 and has an exhaust liner 10 supported within the exhaust duct 8 by suitable supporting structure (not shown).

The rear casing 4 comprises a main body 12 and an end section 14. In normal operation of the engine, the main casing 12 and the end section 14 are secured together with a clamping member 16 which comprises a circumferential channel which engages flanges 18, 20 on the mating ends of the main casing 12 and the end section 14. The flanges 18, 20 have mating inner surfaces which meet at a joint 22. At the radially inner end of the joint 22, the flange 18 has a circumferential recess 23 which accommodates a circumferential rib 24 of the flange 20, so as to provide axial alignment of the main body 12 and the end section 14.

The outer surfaces 26, 28 of the flanges 18, 20 converge in the radially outward direction. The circumferential channel of the clamping member has internal surfaces which are complementary to the external surfaces 26, 28 so that, when the circumferential channel is tensioned around the flanges 18, 20 by means of a suitable tensioning arrangement, the flanges 18, 20 are forced into secure engagement with each other.

At the end of the end section 14 away from the flange 20, there is a circumferential enlargement 30 provided with an internal circumferential groove 32 receiving an annular seal 34. The seal 34 is thus situated radially between the end section 14 and the exhaust duct 8 to prevent the escape of gas from the interior of the casing 4 and the exhaust duct 8.

As with the main body 12 and the exhaust duct 8, the end section 14 supports an intermediate liner 36.

In operation, exhaust gas flows in the passage defined between the exhaust cone 2 and the liners 6, 36, 10. Cooling air is supplied to the annular duct defined between the rear casing 4 and the exhaust duct 8 on the outside and the liners 6, 36, 10 on the inside. Gaps 38, 40 between the liners 6, 36, 10 enable some of the cooling air to bleed through the assembly of liners into the exhaust flow.

If access is required to the interior of the engine, for example for inspection purposes, it may be desirable to gain such access from the rear of the engine. However, in some circumstances, the nature of the exhaust duct 8 may make such access difficult or impossible. Furthermore, some airframe designs may require the exhaust duct 8 to be fixed to the airframe in such a way that it cannot conveniently be displaced away from the engine, and in particular from the rear casing 4. Similarly, such airframe designs make it difficult to remove the engine and the exhaust duct as a unit without major dismantling (and subsequent major re-assembly) of the airframe.

In order to avoid such difficulties, the main body 12 of the rear casing 4 and the end section 14 can be separated from one another at the flanges 18, 20. Once the clamping member 16 is disengaged from the flanges 18, 20, the end section 14 can be displaced away from the main body 12, the seal 34 then sliding over the exhaust duct 8. This movement of the end section 14 takes with it the associated liner 36, leaving an annular gap 42, as shown in FIG. 3, through which, for example, an inspection instrument (such as an intrascope) can be introduced. Alternatively, since the main casing 12 is separated from the exhaust duct 8, it is possible to remove the engine without disturbing the exhaust duct 8.

Refitting of the end section 14 to the main body 12 is the reverse of the separation process, the end section 14 simply being slid axially to the left as seen in FIG. 3 so that the flanges 18, 20 contact each other at the joint 22, and the clamping member is replaced and tensioned.

1. Exhaust duct installation for a gas turbine engine comprising a first tubular member having a central axis, and a second tubular member which is connected to one end of the first tubular member, wherein the first tubular member comprises a main body and an end section which engages the second tubular member, the end section being connected to the main body by a releasable coupling and being axially displaceable with respect to the second tubular member in a direction away from the main body, following release of the coupling.

2. Exhaust duct installation as claimed in claim 1, characterised in that the second tubular member, is received telescopically within the end section.

3. Exhaust duct installation as claimed in claim 2, characterised in that a seal is disposed radially between the end section and the second tubular member.

4. Exhaust duct installation as claimed in claim 1, characterised in that the main body and the end section are provided with end flanges which abut at respective transverse faces.

5. Exhaust duct installation as claimed in claim 4, characterised in that the transverse faces of the end flanges are provided with axial locating means.

6. Exhaust duct installation as claimed in claim 1, characterised in that the releasable coupling comprises a clamping member releasably fitted over the flanges.

7. Exhaust duct installation as claimed in claim 6, characterised in that the end flanges, have radially outwardly convergent external surfaces, the clamping member comprising a circumferential channel having internal surfaces which are complementary to the external surfaces of the end flanges, the clamping member further comprising means for circumferentially tensioning the circumferential channel.

8. Exhaust duct installation as claimed in claim 1, characterised in that a liner assembly is supported within the main body, the end section and the second tubular member, the liner assembly including a liner section which is supported by the end section.

9. Exhaust duct installation as claimed in claim 1, characterised in that the first tubular member comprises a casing of a gas turbine engine, and the second tubular member comprises an exhaust duct for the gas turbine engine.

10. A gas turbine engine comprising an exhaust duct installation in accordance with claim 9.

11. An aircraft comprising an airframe accommodating a gas turbine engine in accordance with claim 10, characterised in that the exhaust duct is fixed with respect to the airframe.
